(19) United States
(12) Patent Application Publication
(10) Pub. No.: US 2022/0092302 A1
(43) Pub. Date: Mar. 24, 2022

(54) SKELETON RECOGNITION METHOD, COMPUTER-READABLE RECORDING MEDIUM STORING SKELETON RECOGNITION PROGRAM, SKELETON RECOGNITION SYSTEM, LEARNING METHOD, COMPUTER-READABLE RECORDING MEDIUM STORING LEARNING PROGRAM, AND LEARNING DEVICE

(71) Applicant: FUJITSU LIMITED, Kawasaki-shi (JP)

(72) Inventor: Yoshihisa Asayama, Kawasaki (JP)

(73) Assignee: FUJITSU LIMITED, Kawasaki-shi (JP)

(21) Appl. No.: 17/542,425

(22) Filed: Dec. 5, 2021

Related U.S. Application Data
(63) Continuation of application No. PCT/JP2019/026746, filed on Jul. 4, 2019.

(51) Int. Cl. G06K 9/00; G06T 7/50; G06T 7/70

(52) U.S. Cl. CPC G06K 9/00369; G06T 7/50; G06T 2207/30196; G06T 2207/20081; G06T 7/70

(57) ABSTRACT

A computer-implemented method of skeleton recognition, the method including: acquiring, from a distance image of an object, a learning model that recognizes heat map images obtained by projecting likelihoods of a plurality of joint positions of the object from a plurality of directions; inputting a distance image to be processed to the learning model and acquiring heat map images in each of the plurality of directions; calculating three-dimensional coordinates regarding the plurality of joint positions of the object, using the heat map images in each of the plurality of directions and information that indicates a relative positional relationship of the plurality of directions; and outputting a skeleton recognition result that includes the three-dimensional coordinates regarding the plurality of joint positions.

### CROSS-REFERENCE TO RELATED APPLICATION

This application is a continuation application of International Application PCT/JP2019/026746 filed on Jul. 4, 2019 and designated the U.S., the entire contents of which are incorporated herein by reference.

### FIELD

The embodiments discussed herein are related to a skeleton recognition method, a skeleton recognition program, a skeleton recognition system, a learning method, a learning program, and a learning device.

### BACKGROUND

In a wide range of fields such as gymnastics and medical care, recognition of skeletons of humans such as athletes and patients is performed. In recent years, a technique for recognizing a three-dimensional skeleton using a color image and a technique for recognizing a three-dimensional skeleton using a distance image have been known. Note that recognizing a skeleton means estimating three-dimensional positions of each of a plurality of joints.

For example, a skeleton recognition technique using color images first estimates two-dimensional positions of joints by recognizing a heat map image from an image, and recognizes a heat map image with the number of resolutions that has been increased to two in a depth direction in the second stage, using a coarse-to-fine method. In this way, the skeleton recognition technique estimates three-dimensional positions of joints by recognizing a heat map image with the number of resolutions in the depth direction that has been finally increased to sixty four, and estimates a three-dimensional skeleton by estimating the three-dimensional positions of all the joints.

Furthermore, a skeleton recognition technique using a distance image estimates two-dimensional positions of joints from the distance image, using the random forest method, and estimates three-dimensional positions of the joints by calculating depth values from pixel values of respective joints, using a calculation formula set in advance for each joint.

Examples of the related art include as follows: Japanese Laid-open Patent Publication No. 2015-211765; International Publication Pamphlet No. WO 2018/207351; Japanese Laid-open Patent Publication No. 2012-120647; Georgios Pavlakos et al, “Coarse-to-Fine Volumetric Prediction for Single-Image 3D Human Pose”, CVPR 2017, 26 Jul. 2017; and Jamie Shotton et al, “Real-Time Human Pose Recognition in Parts from Single Depth Images”, CVPR 2011.

### SUMMARY

According to an aspect of the embodiments, there is provided a computer-implemented method of skeleton recognition. In an example, the method includes: acquiring, from a distance image of an object, a learning model that recognizes heat map images obtained by projecting likelihoods of a plurality of joint positions of the object from a plurality of directions; inputting a distance image to be processed to the learning model and acquiring heat map images in each of the plurality of directions; calculating three-dimensional coordinates regarding the plurality of joint positions of the object, using the heat map images in each of the plurality of directions and information that indicates a relative positional relationship of the plurality of directions; and outputting a skeleton recognition result that includes the three-dimensional coordinates regarding the plurality of joint positions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a system including a recognition device according to a first embodiment;

FIG. 2 is a diagram for describing learning processing and recognition processing according to the first embodiment;

FIG. 3 is a functional block diagram illustrating functional configurations of a learning device and a recognition device according to the first embodiment;

FIG. 4 is a diagram illustrating an example of definition information stored in a skeleton definition database (DB);

FIG. 5 is a diagram illustrating an example of learning data;

FIGS. 6A and 6B are diagrams illustrating an example of a distance image and heat map images;

FIG. 7 is a diagram illustrating an example of information stored in a calculation result DB;

FIG. 8 is a diagram for describing a three-dimensional skeleton calculation image;

FIG. 9 is a flowchart illustrating a flow of learning processing according to the first embodiment;

FIG. 10 is a flowchart illustrating a flow of recognition processing according to the first embodiment;

FIG. 11 is a diagram for describing acquisition of parallax information according to a second embodiment;

FIG. 12 is a flowchart illustrating a flow of recognition processing according to the second embodiment; and

FIG. 13 is a diagram for describing a hardware configuration example.

### DESCRIPTION OF EMBODIMENTS

For example, in the skeleton recognition technique using color images, the number of stages needs to be increased in order to reduce the resolution in the depth direction. However, in a case where the number of resolutions is 64 as disclosed in the existing technique, it becomes about 3.2 cm in one area when ±1 m is decomposed into 64 pieces, and the accuracy in the depth direction is low. For example, since the resolution is large, recognition with high accuracy is difficult. Furthermore, estimation is performed for a three-dimensional voxel space, the amount of memory becomes enormous, which is not distant.

Furthermore, in the skeleton recognition technique using a distance image, it is required to divide and learn the image into a plurality of models for each posture in order to recognize the skeleton with high accuracy. Then, it takes an enormous amount of time to learn the plurality of models. Therefore, to improve the accuracy, how to prepare the models of many postures is needed, and in a case where the models are not sufficiently prepared, the accuracy of skeleton recognition is lowered. Furthermore, since a distance value is not known when a portion is hidden, an accurate depth value is not able to be calculated, and the recognition accuracy is lowered.

In view of the foregoing, these existing techniques have problems that the accuracy of skeleton recognition is not sufficient, and a huge amount of time is needed for advance preparation in order to obtain sufficient accuracy.

Therefore, in one aspect, an objective is to provide a skeleton recognition method, a skeleton recognition program, a skeleton recognition system, a learning method, a learning program, and a learning device capable of improving skeleton recognition accuracy without preparing a model for each posture, as compared with the existing techniques.

Hereinafter, embodiments of a skeleton recognition method, a skeleton recognition program, a skeleton recognition system, a learning method, a learning program, and a learning device will be described in detail with reference to the drawings. Note that the embodiments are not limited to the present disclosure. Furthermore, each of the embodiments may be appropriately combined within a range without inconsistency.

### First Embodiment

[Overall Configuration]

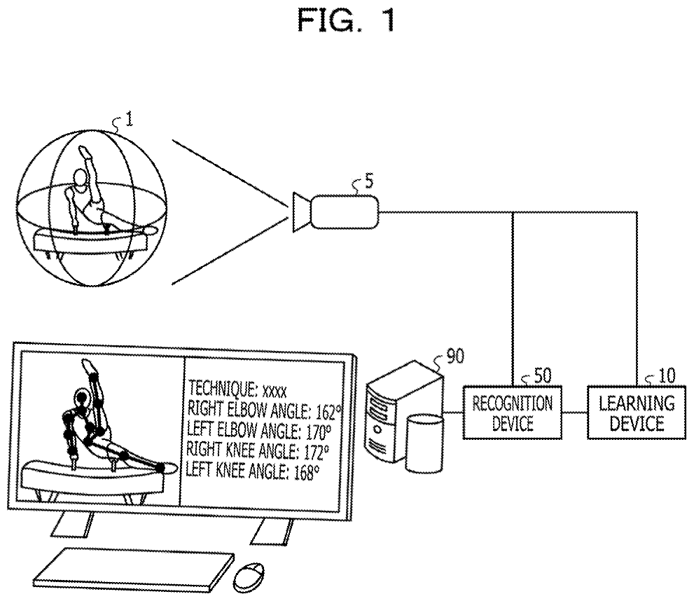

FIG. 1 is a diagram illustrating an overall configuration example of a system including a recognition device according to a first embodiment. As illustrated in FIG. 1, this system has a 3D laser sensor 5, a learning device 10, a recognition device 50, and a scoring device 90, captures three-dimensional data of a performer 1 who is an object, and recognizes a skeleton and the like, and scores accurate techniques. Note that, in the present embodiment, as an example, an example of recognizing skeleton information of a performer in a gymnastics competition will be described. Furthermore, in the present embodiment, two-dimensional coordinates of a skeleton position or the skeleton position of the two-dimensional coordinates may be simply described as two-dimensional skeleton position or the like.

Generally, the current scoring method in gymnastics competition is visually performed by a plurality of judges. However, with sophistication of techniques, there are increasing cases where it is difficult for the judges to visually score performance. In recent years, an automatic scoring system and a scoring support system for scoring competitions using a 3D laser sensor 5 have been known. For example, in these systems, the 3D laser sensor 5 acquires a distance image, which is three-dimensional data of an athlete, and recognizes a skeleton, which is, for example, an orientation of each joint and an angle of each joint of the athlete from the distance image. Then, in the scoring support system, a result of skeleton recognition is displayed by a 3D model, so that the judges are supported to conduct more accurate scoring by, for example, checking a detailed situation of the performer. Furthermore, in the automatic scoring system, a performed technique or the like is recognized from the result of skeleton recognition, and scoring is performed according to a scoring rule.

Here, in the scoring support system and the automatic scoring system, it is required to perform scoring support or automatic scoring for the continually performed performances in a timely manner. The existing methods of recognizing a performer's three-dimensional skeleton from a distance image or a color image causes a long processing time due to insufficient memory or the like and a decrease in skeleton recognition accuracy.

For example, in the mode where the result of automatic scoring by the automatic scoring system is provided to the judge and the judge compares the result with his/her own scoring result, provision of information to the judge is delayed in a case of using the existing techniques. Moreover, due to the decrease in skeleton recognition accuracy, subsequent technique recognition may be failed, and as a result, a score determined by the technique may also be failed.

Similarly, when the angle and position of the performer's joints are displayed using a 3D model in the scoring support system, a situation where the time until display is delayed or the displayed angle or the like is incorrect may occur. In this case, the scoring by the judge using this scoring support system may result in wrong scoring.

As described above, if the skeleton recognition accuracy is poor or if the processing takes time in the automatic scoring system or the scoring support system, scoring errors will occur and the scoring time will be lengthened.

Therefore, the system according to the first embodiment recognizes, by machine learning using a distance image obtained from the 3D laser sensor 5, the person's three-dimensional skeleton at high speed with high accuracy in any posture, regardless of whether a portion of the performer 1 is hidden or not hidden by instrument or the like.

Here, in the skeleton recognition described in the present embodiment, the skeleton recognition of the performer 1 is executed using the distance image and information indicating a relative positional relationship of respective virtual viewpoints of two heat maps. In the first embodiment, the three-dimensional skeleton is recognized using a heat map image in a front direction, which is a viewpoint (reference viewpoint) of the distance image itself given to input, and a heat map image in a right above direction, which is a heat map image of a virtual viewpoint assumed at a position translated and rotated by an arbitrary numerical value with respect to the reference viewpoint.

First, each of the devices constituting the system in FIG. 1 will be described. The 3D laser sensor 5 is an example of a sensor device that measures (senses) the distance of an object for each pixel using an infrared laser or the like. The distance image includes a distance to each pixel. For example, the distance image is a depth image representing a depth of the object viewed from the 3D laser sensor (depth sensor) 5.

The learning device 10 is an example of a computer device that learns a learning model for skeleton recognition. Specifically, the learning device 10 learns a learning model, using machine learning such as deep learning using the distance image acquired in advance, three-dimensional skeleton position information, and the like as learning data.

The recognition device 50 is an example of a computer device that recognizes a skeleton regarding the orientation, position, and the like of each joint of the performer 1, using the distance image measured by the 3D laser sensor 5. Specifically, the recognition device 50 inputs the distance image measured by the 3D laser sensor 5 into the trained learning model learned by the learning device 10, and recognizes the skeleton on the basis of an output result of the learning model. Thereafter, the recognition device 50 outputs the recognized skeleton to the scoring device 90. Note that, in the present embodiment, information obtained as a result of skeleton recognition is information regarding the three-dimensional position of each joint.

The scoring device 90 is an example of a computer device that specifies transition of movement obtained from the position and orientation of each joint of the performer, using the recognition result information input from the recognition device 50, and specifies and scores the technique performed by the performer.

Here, the learning processing will be described. The learning device 10 uses the distance image and the three-dimensional skeleton position information in the distance image in the learning processing. Then, the learning device 10 generates heat map images obtained by projecting likelihoods of a plurality of joint positions of the object from a plurality of directions, from the three-dimensional skeleton position information. For example, the learning device 10 generates a heat map image in the front direction of when the performer is viewed from the front (hereinafter may be described as a front heat map, an xy heat map, or the like), and a heat map image in the right above direction of when the performer is viewed from right above (hereinafter may be described as a right above heat map, an xz heat map, or the like). Then, the learning device 10 learns the learning model, using training data having the distance image as an explanatory variable and the heat map images in the two directions associated with the distance image as objective variables.

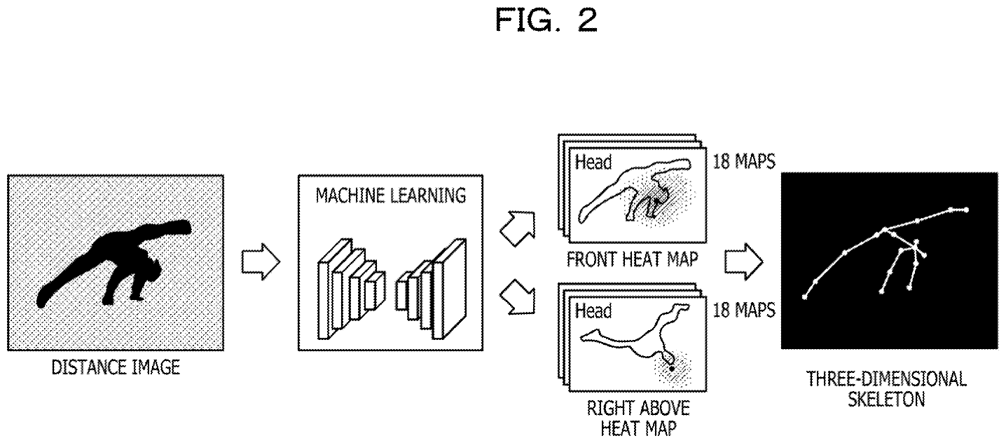

FIG. 2 is a diagram for describing recognition processing according to the first embodiment. As illustrated in FIG. 2, the recognition device 50 acquires the distance image of the performer 1 by the 3D laser sensor 5, inputs the distance image into the trained learning model, and recognizes the two-dimensional heat map images in the two directions by the number of joints. Then, the recognition device 50 calculates two-dimensional coordinates of skeleton positions on the image from the two-dimensional heat map images corresponding to the number of joints in each direction, and calculates three-dimensional coordinates of the skeleton position of the performer 1 from the two-dimensional skeleton positions in each direction and the center of gravity of a human area.

As described above, in the system according to the first embodiment, input data to the learning model obtained by machine learning is the distance image, and outputs are the heat map images viewed from the plurality of directions for each of the plurality of joints. The system according to the first embodiment comprehensively recognizes the skeleton of the performer 1, using the heat map images in each direction for the number of joints and the distance image that is also used as the input data to the learning model. For example, the system generates a skeleton recognition result regarding three-dimensional positions and the like of the joints. As a result, since the system according to the first embodiment can use the learning model independently of posture, the system may recognize the skeleton of the performer 1 with high accuracy without preparing a model for each posture, as compared with the existing techniques in which the model for each posture is prepared.

[Functional Configuration]

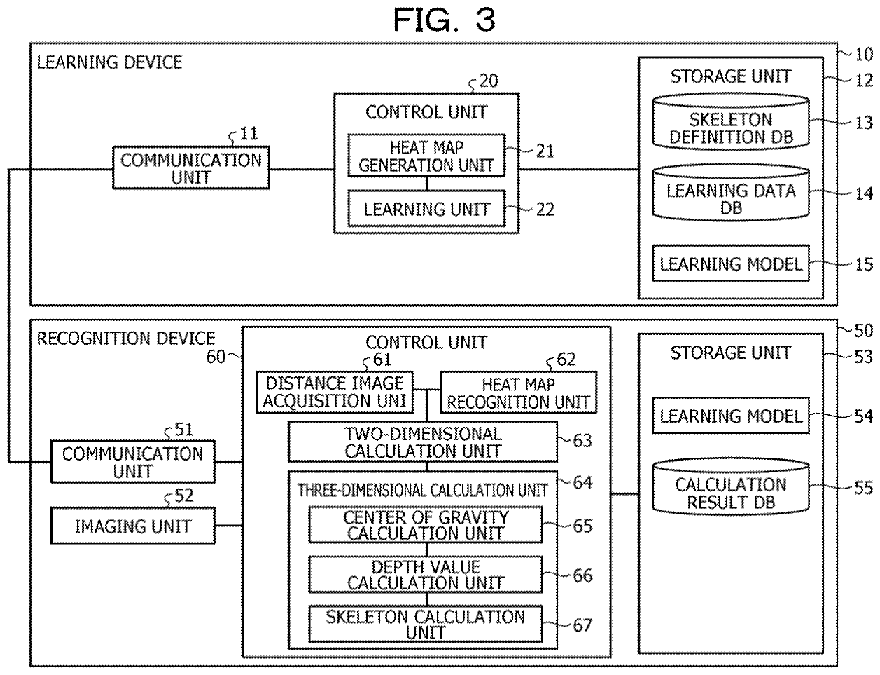

FIG. 3 is a functional block diagram illustrating functional configurations of the learning device 10 and the recognition device 50 according to the first embodiment. Note that the scoring device 90 is a device that recognizes a technique in performance, using skeleton information, and scores the performance of a performer.

(Functional Configuration of Learning Device 10)

As illustrated in FIG. 3, the learning device 10 includes a communication unit 11, a storage unit 12, and a control unit 20. The communication unit 11 is a processing unit that controls communication with other devices and is, for example, a communication interface or the like. For example, the communication unit 11 outputs a learning result and the like to the recognition device 50.

The storage unit 12 is an example of a storage device that stores data and a program or the like executed by the control unit 20 and is, for example, a memory, a hard disk, or the like. The storage unit 12 stores a skeleton definition DB 13, a learning data DB 14, and a learning model 15.

The skeleton definition DB 13 is a database that stores definition information for specifying each joint on a skeleton model. The definition information stored here may be measured for each performer by 3D sensing with the 3D laser sensor, or may be defined using a skeleton model of a general body shape.

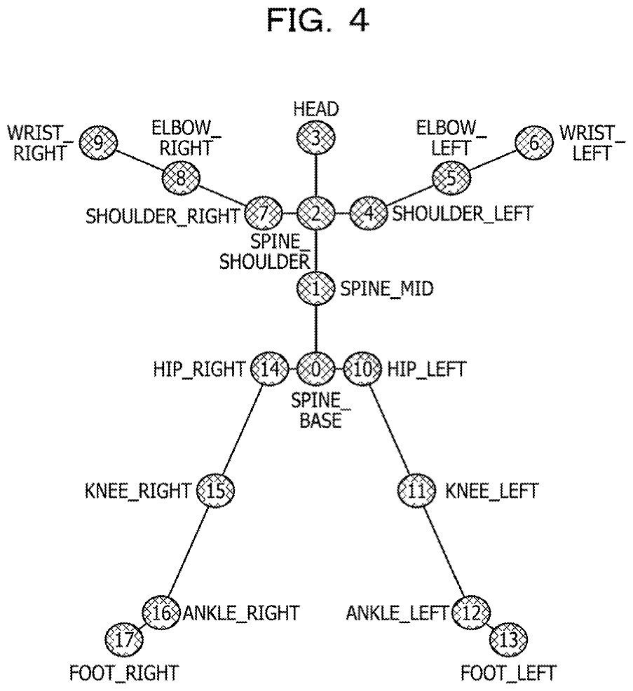

FIG. 4 is a diagram illustrating an example of the definition information stored in the skeleton definition DB 13. As illustrated in FIG. 4, the skeleton definition DB 13 stores 18 pieces of (numbers 0 to 17) definition information in which joints specified by a known skeleton model are numbered. For example, as illustrated in FIG. 4, a right shoulder joint (SHOULDER_RIGHT) is assigned with number 7, a left elbow joint (ELBOW_LEFT) is assigned with number 5, a left knee joint (KNEE_LEFT) is assigned with number 11, and a right hip joint (HIP_RIGHT) is assigned with number 14. Here, in the embodiment, an X coordinate of the right shoulder joint of number 8 may be described as X8, a Y coordinate as Y8, and a Z coordinate as Z8. Note that, for example, a Z axis can be defined as a distance direction from the 3D laser sensor 5 toward an object, a Y axis can be defined as a height direction perpendicular to the Z axis, and an X axis can be defined as a horizontal direction.

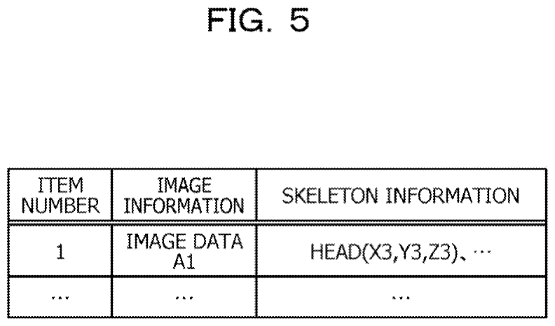

The learning data DB 14 is a database that stores the learning data used to learn the learning model for recognizing a skeleton. FIG. 5 is a diagram illustrating an example of the learning data. As illustrated in FIG. 5, the learning data DB 14 stores “item number, image information, and skeleton information” in association with one another.

The “item number” stored here is an identifier that identifies the learning data. The “image information” is data of the distance image in which the positions of joints and the like are known. The “skeleton information” is the position information of the skeleton, and is the joint positions (three-dimensional coordinates) corresponding to the 18 joints illustrated in FIG. 4. The example of FIG. 4 illustrates that the positions of the 18 joints including the coordinates “X3, Y3, Z3” of HEAD are known in “image data A1” that is the distance image.

For example, the image information is used as the explanatory variable, and the 18 front heat map images and the 18 right above heat map images generated from the skeleton information are used as the objective variables (correct answer labels), for supervised learning. Note that the directions are arbitrary, but two or more directions having line-of-sight directions that are significantly different from each other, such as the front and right above, are selected.

The learning model 15 is a trained learning model. For example, the learning model 15 is a learning model that predicts 18 front heat map images and 18 right above heat map images from the distance image, the learning model 15 being learned by machine learning or the like.

The control unit 20 is a processing unit that controls the entire learning device 10 and is, for example, a processor or the like. The control unit 20 has a heat map generation unit 21 and a learning unit 22, and executes the learning processing for the learning model. Note that the heat map generation unit 21 and the learning unit 22 are examples of electronic circuits included in the processor or examples of processes performed by the processor. Furthermore, the heat map generation unit 21 corresponds to a generation unit, and the learning unit 22 corresponds to a learning unit.

The heat map generation unit 21 is a processing unit that generates a heat map image. Specifically, the heat map generation unit 21 generates the front heat map image and the right above heat map image for each of the 18 joints, using each skeleton information stored in the learning data DB 14. For example, the heat map generation unit 21 uses the three-dimensional position of a certain joint included in the skeleton information associated with each distance image and projects the three-dimensional position of the joint onto planes viewed from the front and right above, respectively. Then, the heat map generation unit 21 generates the heat map image indicating an existence probability of a certain joint. Note that, for each of the 18 joints stored in the skeleton definition DB 13, two types of heat map images in the cases of projecting the each joint onto the planes viewed from the front and right above are generated. Then, the heat map images in the plurality of directions generated for each of the plurality of joints are stored as correct answer information in association with the image information (distance image) stored in the learning data DB 14.

Note that various known methods can be adopted for generation of the heat map images For example, the heat map generation unit 21 generates the heat map image, setting the coordinate position set in the skeleton information as a position with the highest likelihood (presence probability), a position at a radius of X cm from the position with the highest likelihood as a position with the second highest likelihood, and a position at the radius X cm from the position with the second highest likelihood as a position with the third highest likelihood. Note that X is a threshold value and is an arbitrary number.

The learning unit 22 is a processing unit that learns the learning model that outputs the heat map images in the two directions from the distance image. Specifically, the learning unit 22 learns the learning model, using the training data having the image information stored in the learning data DB 14 as the explanatory variable, and the front heat map images and the right above heat map images generated by the heat map generation unit 21 as the objective variables.

For example, the learning unit 22 inputs the distance image data into a neural network as input data. Then, the learning unit 22 acquires the heat map images of each joint as an output of the neural network. Thereafter, the learning unit 35 compares the 18 front heat map images and the 18 right above heat map images that are the outputs of the neural network with the 18 front heat map images and the 18 right above heat map images generated by the heat map generation unit 21. Then, the learning unit 22 learns the neural network, using an error back propagation method or the like so that an error of each joint is minimized.

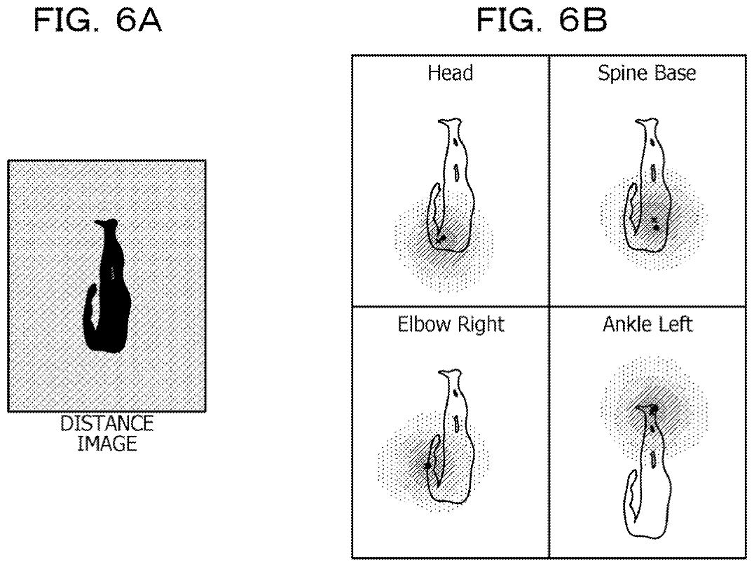

Here, the training data (a set of the distance image and a heat map image group) will be described. FIGS. 6A and 6B are diagrams illustrating an example of a distance image and heat map images. As illustrated in FIG. 6A, the distance image is data including the distance from the 3D laser sensor 5 to the pixel, and the closer the distance from the 3D laser sensor 5, the darker the color is displayed. Furthermore, as illustrated in FIG. 6B, the heat map image is generated for each joint and visualizes the likelihood of each joint position. The coordinate position having the highest likelihood has a darker color. Note that, normally, the shape of a person is not displayed in the heat map image, but in FIGS. 6A and 6B, the shape of the person is illustrated for easy understanding of the description. However, the illustration does not limit the display format of the image.

Furthermore, when the learning is completed, the learning unit 22 stores the learning model 15 in which various parameters in the neural network are learned as a learning result in the storage unit 12. Note that the timing to terminate the learning can be freely set, such as a point of time when learning using a predetermined number or more of items of learning data is completed, or a point of time when the error falls under a threshold value. Furthermore, although the learning model using the neural network has been described here as an example, the present embodiment is not limited to the example and another machine learning, such as convolutional neural network (CNN), can be used. Furthermore, the learned parameters, instead of the learning model 15, can be stored in the storage unit 12.

(Functional Configuration of Recognition Device 50)

As illustrated in FIG. 3, the recognition device 50 includes a communication unit 51, an imaging unit 52, a storage unit 53, and a control unit 60. The communication unit 51 is a processing unit that controls communication with other devices and is, for example, a communication interface or the like. For example, the communication unit 51 acquires the trained learning model from the learning device 10, stores the trained learning model in the storage unit 53, and transmits the skeleton information of the performer 1 to the scoring device 90.

The imaging unit 52 is a processing unit that captures the distance image of the performer 1, and controls, for example, the 3D laser sensor 5 to capture the performer 1. For example, the imaging unit 52 captures the distance image of the performer 1 and outputs data of the captured distance image to the control unit 60. Note that the imaging unit 52 may be arranged outside the recognition device 50.

The storage unit 53 is an example of a storage device that stores data and a program or the like executed by the control unit 60 and is, for example, a memory, a hard disk, or the like. The storage unit 53 stores a learning model 54 and a calculation result DB 55. Note that the storage unit 53 can also store the definition information of the skeleton stored in the skeleton definition DB 13 of the learning device 10.

The learning model 54 is a database that stores the learning model learned by the learning device 10. Since the learning model 54 stores similar information to the learning model 15, detailed description thereof will be omitted.

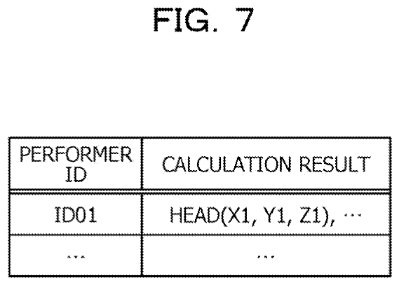

The calculation result DB 55 is a database that stores the information of each joint calculated by the control unit 60, which will be described below. Specifically, the calculation result DB 55 stores the result of the skeleton recognition of the performer 1 included in each distance image. FIG. 7 is a diagram illustrating an example of information stored in the calculation result DB 55. As illustrated in FIG. 7, the calculation result DB 55 stores “a performer ID and a calculation result” in association with each other. The “performer ID” stored here is an identifier that identifies the performer, and the “calculation result” is the calculation result of each joint illustrated in FIG. 4. The example of FIG. 7 illustrates that (X1, Y1, Z1) is calculated as the coordinates of HEAD for the performer (ID01). Note that the result of the skeleton recognition can be associated with the time of performance, the performer, and the like.

The control unit 60 is a processing unit that controls the entire recognition device 50 and is, for example, a processor or the like. The control unit 60 has a distance image acquisition unit 61, a heat map recognition unit 62, a two-dimensional calculation unit 63, and a three-dimensional calculation unit 64, and executes the skeleton recognition using the learning model. Note that the distance image acquisition unit 61, the heat map recognition unit 62, the two-dimensional calculation unit 63, and the three-dimensional calculation unit 64 are examples of electronic circuits included in the processor or examples of processes executed by the processor. Furthermore, the heat map recognition unit 62 corresponds to an acquisition unit, the two-dimensional calculation unit 63 corresponds to a first calculation unit, and the three-dimensional calculation unit 64 corresponds to a second calculation unit.

The distance image acquisition unit 61 is a processing unit that acquires the distance image of the performer 1. For example, the distance image acquisition unit 61 acquires the distance image captured by the 3D laser sensor 5 from the imaging unit 52 and outputs the distance image to the three-dimensional calculation unit 64, the heat map recognition unit 62, and the like.

The heat map recognition unit 62 is a processing unit that recognizes the heat map images from the distance image using the trained learning model learned by the learning device 10. For example, the heat map recognition unit 62 acquires the trained learning model 54 using the neural network from the storage unit 53.

Next, the heat map recognition unit 62 inputs the distance image acquired from the distance image acquisition unit 61 to the trained learning model, and acquires, as output results, the front heat map images of each of the 18 joints, and the right above heat map images of each of the 18 joints. Then, the heat map recognition unit 62 outputs each of the heat map images recognized in this way to the two-dimensional calculation unit 63.

The two-dimensional calculation unit 63 is a processing unit that calculates the skeleton on the image from the two-dimensional heat map images. For example, the two-dimensional calculation unit 63 acquires the front heat map images of the 18 joints and the right above heat map images of the 18 joints from the heat map recognition unit 62. Then, the two-dimensional calculation unit 63 specifies the position of each joint from the highest value pixel of each heat map image, calculates the two-dimensional coordinates of the skeleton position on the image, and outputs the two-dimensional coordinates to the three-dimensional calculation unit 64.

For example, the two-dimensional calculation unit 63 specifies the pixel with the highest value of the heat map image for each of the front heat map images of the 18 joints, and individually specifies the position of each joint on the image. Then, the two-dimensional calculation unit 63 combines the joint positions specified from the front heat map images to specify 18 joint positions when the performer 1 is viewed from the front.

Similarly, the two-dimensional calculation unit 63 specifies the pixel with the highest value of the heat map image for each of the right above heat map images of the 18 joints, and individually specifies the position of each joint on the image. Then, the two-dimensional calculation unit 63 combines the joint positions specified from the right above heat map images to specify 18 joint positions when the performer 1 is viewed from right above.

The three-dimensional calculation unit 64 is a processing unit having a center of gravity calculation unit 65, a depth value calculation unit 66, and a skeleton calculation unit 67, and which calculates the three-dimensional skeleton position, using the two-dimensional skeleton positions in the front direction and the right above direction and the center of gravity of the human area.

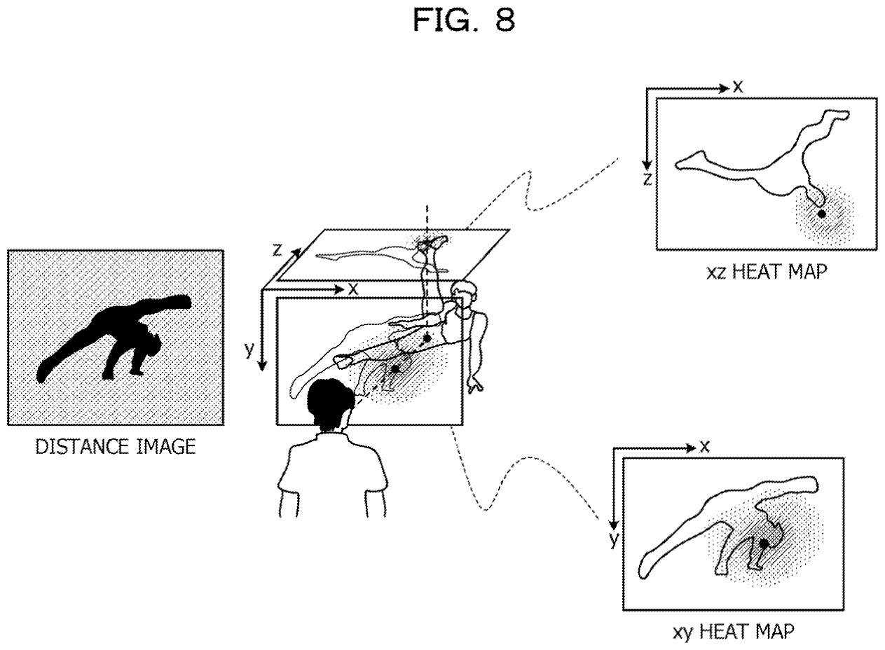

Here, an image at the time of calculating a three-dimensional skeleton will be described. FIG. 8 is a diagram for describing a three-dimensional skeleton calculation image. As illustrated in FIG. 8, the distance image captured in the present embodiment is, for example, a distance image in x-axis and y-axis directions in a case where the performer's horizontal direction is the x axis, the vertical direction is the y axis, and the depth direction is the z axis (the distance image may be simply described as a distance image or an xy distance image).

Furthermore, the front heat map images of the 18 joints recognized by the heat map recognition unit 62 are images when the performer 1 is viewed from the front, and are xy heat map images captured in the x-axis-y-axis directions. Furthermore, the right above heat map images of the 18 joints recognized by the heat map recognition unit 62 are images when the performer 1 is viewed from right above, and are xz heat map images captured in the x-axis-z-axis directions.

The three-dimensional calculation unit 64 calculates the center of gravity of the human area reflected in the distance image (hereinafter may be referred to as human center of gravity), and calculates depth values for 18 joints from the human center of gravity and the two-dimensional skeleton positions on the xz heat map images. Then, the three-dimensional calculation unit 64 calculates the three-dimensional skeleton position (three-dimensional coordinates of the skeleton position) using the depth values of the 18 joints and the two-dimensional skeleton positions on the xy heat map images.

The center of gravity calculation unit 65 is a processing unit that calculates the center of gravity of the human area from the distance image. For example, the center of gravity calculation unit 65 acquires the distance image of the performer from the distance image acquisition unit 61. Here, the distance image includes pixels in which the person is reflected, and each pixel stores a Z value from the 3D image sensor to the person (performer 1). The Z value is a pixel value of the pixel in which the person is reflected on the distance image. Note that, generally, a value in the z axis that is the direction from the 3D image sensor toward the object, among values obtained by converting distance information of the distance image into coordinate values represented by coordinate axes of xyz orthogonal coordinates, is referred to as the Z value.

Therefore, the center of gravity calculation unit 65 specifies each pixel located at the distance from the 3D image sensor, the distance being less than a threshold value, and having the pixel value that is equal to or larger than a fixed value. For example, the center of gravity calculation unit 65 specifies the performer 1 on the distance image. Then, the center of gravity calculation unit 65 calculates an average value of the pixel values of each of the specified pixels, and outputs the average value as the center of gravity of the human area to the depth value calculation unit 66 and the like.

The depth value calculation unit 66 is a processing unit that calculates the depth values for the 18 joints, using the center of gravity of the human area and the two-dimensional skeleton positions on the right above images when the performer 1 is viewed from right above. For example, the depth value calculation unit 66 specifies the pixels each having the pixel value that is equal to or larger than a fixed value from the right above heat map images (xz heat map images) of the 18 joints acquired from the heat map recognition unit 62, and specifies the area in which the performer is reflected on the image. Then, the depth value calculation unit 66 calculates the two-dimensional coordinates (x, z) of the human area specified on each xy heat map image.

Here, the distance image is created such that the center of gravity of the person comes at the center of the image, for example. 1 pixel=10 mm. Therefore, the depth value calculation unit 66 can calculate the Z value in the three-dimensional space according to how far the z value of the two-dimensional coordinate (x, z) of the human area specified on each xz-heat map image is from the center of the distance image.

For example, taking an example in which an image size is set to (320, 320), the center of the image is set to (160, 160), the center of gravity of the human area is set to 6000 mm, and the z value of the head is set to 200, the depth value calculation unit 66 calculates the Z value in the three-dimensional space as “(200−160)×10+6000=6400 mm”. Then, the depth value calculation unit 66 outputs the calculated Z value in the three-dimensional space to the skeleton calculation unit 67.

The skeleton calculation unit 67 is a processing unit that calculates the three-dimensional coordinates of the skeleton position of the performer 1, using the depth values of the 18 joints calculated by the depth value calculation unit 66, and the two-dimensional skeleton positions on the xy heat map images recognized by the heat map recognition unit 62.

Specifically, the skeleton calculation unit 67 acquires the Z value in the three-dimensional space that is the depth values for the 18 joints calculated by the depth value calculation unit 66. Then, the skeleton calculation unit 67 calculates the two-dimensional coordinates of (x, y) on the image from the xy heat map images, using the above method, and calculates a vector in the three-dimensional space from the two-dimensional coordinates (x, y).

For example, the distance image captured by a three-dimensional sensor such as the 3D laser sensor 5 has three-dimensional vector information that passes through each pixel from the origin of the sensor. Therefore, by using this information, the 3-dimensional coordinate values of the object reflected in each pixel can be calculated. Then, the skeleton calculation unit 67 can calculate (X, Y, Z) of the object (performer 1) reflected on the (x, y) coordinates, by using the equation (1), where the three-dimensional vector of the (x, y) coordinates on the xy heat map image is (normX, normY, normZ), and the Z value of the coordinates calculated by the depth value calculation unit 66 is “pixelZ”. In this way, the skeleton calculation unit 67 calculates the three-dimensional coordinates (X, Y, Z) of each joint of the object, for example, the performer 1, captured in each pixel, and transmits the three-dimensional coordinates (X, Y, Z) to the scoring device 90. Note that the scoring device 90 may output information such as a frame number and time information in association with the three-dimensional coordinates of the joints.

$$Coordinate values of object = \begin{matrix}( X = normX * \frac{Z}{normZ} , Y = normY * \frac{Z}{normZ} , Z = pixelZ ) & Equation ( 1 )\end{matrix}$$

[Flow of Processing]

Next, each of the learning processing executed by the learning device 10 and the recognition processing executed by the recognition device 50 will be described.

(Learning Processing)

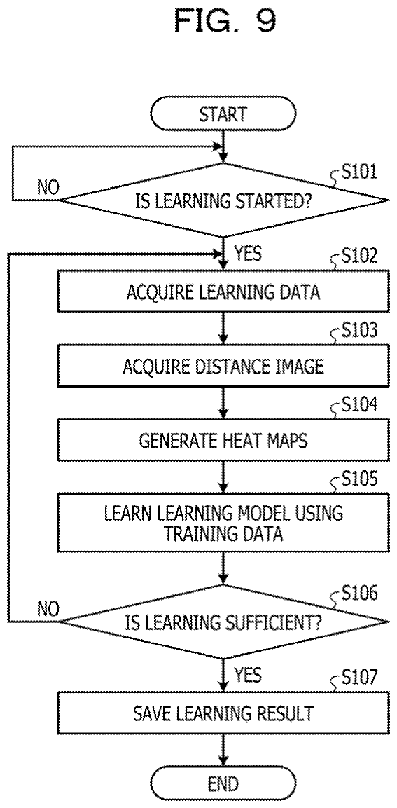

FIG. 9 is a flowchart illustrating a flow of learning processing according to the first embodiment. As illustrated in FIG. 9, when start of the learning processing is instructed (S101: Yes), the heat map generation unit 21 of the learning device 10 acquires the learning data from the learning data DB 14 (S102) and acquires the skeleton information in the learning data (S103).

Next, the heat map generation unit 21 generates the front heat map image and the right above heat map image for each of the 18 joints using the skeleton information, and generates a total of 36 heat map images (S104).

Thereafter, the learning unit 22 learns the learning model using the 36 heat map images and the distance image as training data (S105). Then, in the case where it is determined that the learning is not sufficient according to the accuracy or the like (S106: No), the learning unit 22 executes S102 and the subsequent steps for the next learning data.

On the other hand, in the case where it is determined that the learning is sufficient according to the accuracy or the like (S106: Yes), the learning unit 22 stores the trained learning model in the learning model 15 (S107). Note that the learning model is transmitted from the learning device 10 to the recognition device 50. Furthermore, the order of steps in FIG. 9 can be changed within a consistent range.

(Recognition Processing)

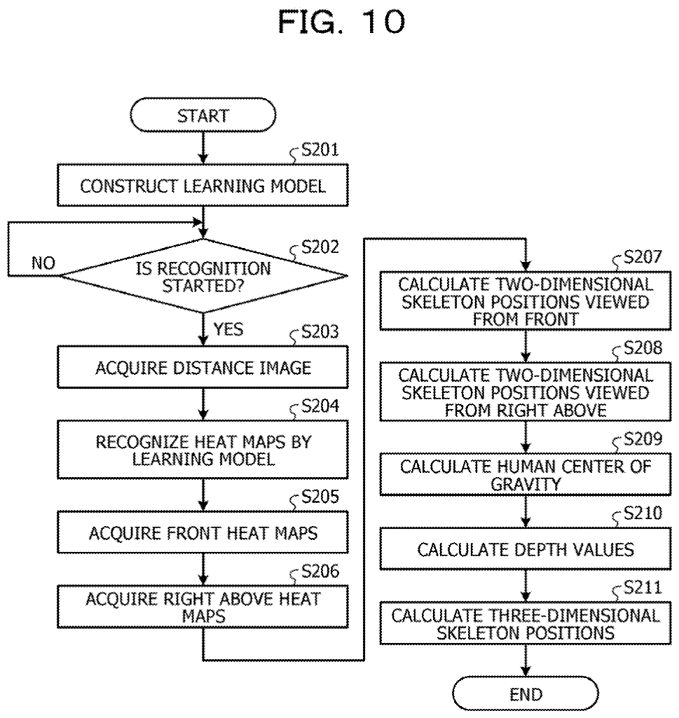

FIG. 10 is a flowchart illustrating a flow of recognition processing according to the first embodiment. As illustrated in FIG. 10, the heat map recognition unit 62 of the recognition device 50 reads the trained learning model from the learning model 54 in advance and constructs the learning model (S201).

Then, when start of the recognition processing is instructed (S202: Yes), the distance image acquisition unit 61 acquires the distance image of the performer 1 using the 3D laser sensor 5 or the like (S203), and the heat map recognition unit 62 inputs the distance image to the trained learning model and recognizes the heat map images in each direction (S204).

As a result, the heat map recognition unit 62 recognizes the two-dimensional heat map images in the front and right above two directions for the 18 joints, and acquires the 18 front heat map images and the 18 right above heat map images (S205 and S206).

Next, the two-dimensional calculation unit 63 calculates the two-dimensional skeleton position on the image from the pixel having the highest likelihood value in each of the 18 front heat map images (S207), and calculates the two-dimensional skeleton position on the image from the pixel having the highest likelihood value in each of the 18 right above heat map images (S208).

Then, the three-dimensional calculation unit 64 calculates the center of gravity (human center of gravity) of the human area reflected in the distance image (S209), and calculates the depth values of the 18 joints from the human center of gravity and the two-dimensional skeleton positions on the right above images (S210). Thereafter, the three-dimensional calculation unit 64 calculates the three-dimensional skeleton positions of the 18 joints of the performer 1, using the depth values of the 18 joints and the two-dimensional skeleton positions on the front images, which are the images of the performer 1 viewed from the front (S211). Note that the order of steps in FIG. 10 can be changed within a consistent range.

[Effects]

As described above, the system according to the first embodiment can acquire the heat maps viewed from a plurality of directions from the distance image obtained from the 3D laser sensor 5, and thus may recognize the three-dimensional positions of joints even if a portion of the performer 1's body is hidden by instrument or the like when viewed from a certain direction. For example, the accuracy of skeleton recognition may be improved. Furthermore, the learning model for obtaining the heat maps from the distance image does not need to be prepared for each posture. Therefore, the three-dimensional skeleton of the performer 1 may be recognized regardless of any posture. Moreover, the system according to the present embodiment has a lower processing load than the existing techniques, and thus may improve the processing speed until the skeleton recognition result is obtained. Therefore, in the automatic scoring system and the scoring support system for scoring competitions using the skeleton recognition result, the accuracy of the automatic scoring and the accuracy of the displayed 3D model may be improved. Moreover, the processing time of these systems may be shortened.

### Second Embodiment

By the way, in the first embodiment, an example of using the front heat map image and the right above heat map image as the information indicating the relative positional relationship of the virtual viewpoints of each of the two heat maps has been described, but the present embodiment is not limited to the example, and heat map images in other directions can also be used. Therefore, in a second embodiment, three-dimensional skeleton is recognized using a heat map image in a front direction, which is a viewpoint (reference viewpoint) of a distance image itself given to input, and a heat map image from a parallax position, which is a heat map image of a virtual viewpoint assumed at a position translated by an arbitrary numerical value with respect to the reference viewpoint.

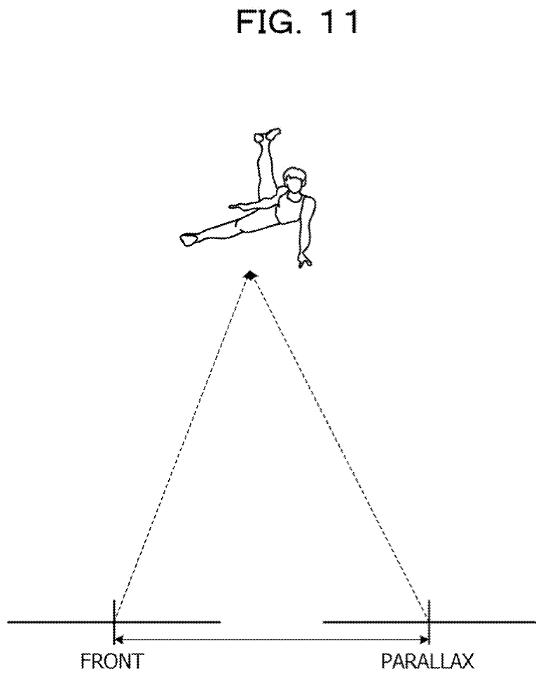

FIG. 11 is a diagram for describing acquisition of parallax information according to the second embodiment. As illustrated in FIG. 11, a learning device 10 learns a learning model for recognizing heat map images in two directions of the front direction and a position moved in a side direction from the front direction as in a parallax image (parallax position) by machine learning. For example, the learning device 10 learns the learning model using a distance image as an explanatory variable, and 18 front heat map images and 18 parallax heat map images viewed from the position moved to the side as in parallax images as objective variables.

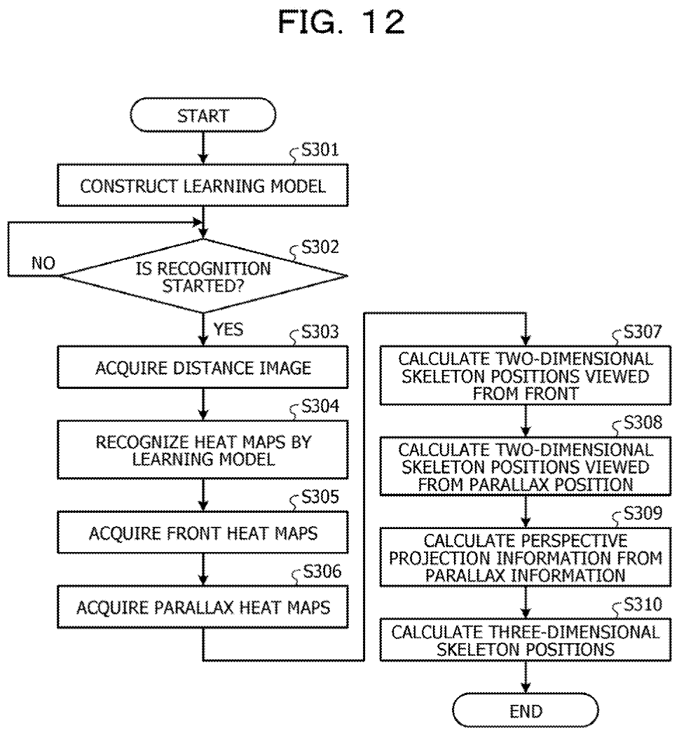

Then, a recognition device 50 inputs the distance image of a performer 1 into a trained learning model, recognizes the 18 front heat map images and the 18 parallax heat map images, and calculates skeleton positions of the performer 1 using these images. Processing according to the second embodiment will be specifically described with reference to FIG. 12. FIG. 12 is a flowchart illustrating a flow of recognition processing according to the second embodiment. Note that since learning processing according to the second embodiment is similarly executed with the difference of the parallax heat map images from the right above heat map images, detailed description is omitted.

As illustrated in FIG. 12, a heat map recognition unit 62 of a recognition device 50 reads the trained learning model from a learning model 54 in advance and constructs the learning model (S301). Then, when start of the recognition processing is instructed (S302: Yes), a distance image acquisition unit 61 acquires the distance image of the performer 1 using a 3D laser sensor 5 or the like (S303), and a heat map recognition unit 62 inputs the distance image to the trained learning model and recognizes the heat map images in each direction (S304).

As a result, the heat map recognition unit 62 recognizes the two-dimensional heat map images in the front and parallax two directions for the 18 joints, and acquires the 18 front heat map images and the 18 parallax heat map images (S305 and S306).

Next, a two-dimensional calculation unit 63 calculates a two-dimensional skeleton position on the image from a highest value pixel in each of the 18 front heat map images (S307), and calculates a two-dimensional skeleton position on the image from a highest value pixel in each of the 18 parallax heat map images (S308).

Thereafter, a three-dimensional calculation unit 64 calculates a perspective projection transformation matrix as perspective projection information to the front images from the parallax information set in advance when the parallax images are acquired (S309). For example, the three-dimensional calculation unit 64 can use various known methods. For example, the three-dimensional calculation unit 64 calculate the perspective projection transformation matrix that puts a viewpoint on a z axis and projects the viewpoint on a plane perpendicular to the z axis, using the parallax information including horizontal and vertical angles of a field of view, distances from the 3D radar sensor to a forefront and an innermost surface, an aspect ratio that is an aspect ratio of a screen, and the like.

Then, the three-dimensional calculation unit 64 calculates three-dimensional skeleton positions for the 18 joints from the two-dimensional skeleton positions of the front images and the parallax images using the perspective projection transformation matrix (S310). Note that the order of steps in FIG. 12 can be changed within a consistent range.

As described above, the learning device 10 can execute learning using the front heat map images and the parallax heat map images, and thus can use the right above heat map images or the parallax heat map images depending on the type of competition or the like. Therefore, versatility and flexibility of the system may be improved. Note that the perspective projection transformation matrix is parameters for projecting an object (three-dimensional) existing in a real space onto an image (two-dimensional). Furthermore, a general stereo method or the like can also be used instead of the perspective projection transformation matrix.

### Third Embodiment

While the embodiments have been described above, the embodiments may be carried out in a variety of different modes in addition to the above-described embodiments.

[Application]

In the above embodiments, the gymnastics competition has been described as an example, but the embodiments are not limited to the example, and can be applied to other competitions in which athletes performs a series of techniques and referees score the techniques. Examples of other competitions include figure skating, rhythmic gymnastics, cheerleading, swimming diving, karate kata, mogul air, and the like. Furthermore, the embodiments can be applied not only to sports but also to posture detection of drivers of trucks, taxis, trains, or the like, and posture detection of pilots.

[Skeleton Information]

Furthermore, in the above embodiments, an example of learning the positions of the 18 joints has been described, but the embodiments are not limited to the example, and one or more joints can be designated for learning. Furthermore, in the above embodiments, the position of each joint has been illustrated and described as an example of the skeleton information, but the embodiments are not limited to the example. Various types of information can be adopted as long as the information can be defined in advance, such as the angle of each joint, the orientation of limbs, the orientation of the face, and the like.

[Numerical Values, Directions, Etc.]

The numerical values and the like used in the above embodiments are merely examples, and do not limit the embodiments and can be arbitrarily changed. Furthermore, in the above embodiments, the heat map images in the two directions have been illustrated and described as an example, but the embodiments are not limited to the example, and heat map images in three or more directions can be targeted.

[Information Indicating Relative Positional Relationship of Virtual Viewpoints]

In the above embodiments, an example of calculating the three-dimensional skeleton positions using the heat map images of the reference viewpoint and the heat map images of the virtual viewpoint assumed at the position translated and rotated by an arbitrary numerical value with respect to the reference viewpoint has been described. However, other information can be used as long as the information indicates a relative positional relationship of virtual viewpoints, and an arbitrarily set rotation matrix value or translation can be used. Here, with reference to a coordinate system A of one virtual viewpoint, information required to match a coordinate system B of the other virtual viewpoint with the coordinate system A is translation [X, Y, Z] and a rotation matrix.

In the case of the first embodiment, the “front” is the viewpoint of the distance image itself given to input. As a relative positional relationship of the “right above” with respect to the “front” with reference to the viewpoint, the rotation matrix is rotation of −90 degrees, and the translation is the Z value of the center of gravity obtained from the distance image in the Z-axis direction and the Y value+α of the center of gravity obtained from the distance image in the Y-axis direction. Note that since α depends on which viewpoint heat map has been learned during learning, for example, in a case where the right above heat map image has been trained as a heat map image viewed from a position 5700 mm right above the center of gravity of the human area during learning, α=5700 mm. For example, in the first embodiment, the translation is [0, α, center of gravity Z] and the rotation is [−90, 0, 0].

In the case of the second embodiment, the “front” is the viewpoint of the distance image itself given to input as in the first embodiment. As a relative positional relationship of “parallax position” with respect to “front” with reference to the viewpoint, the rotation matrix has no change (=rotation 0° in any of the X, Y, and Z axes) and the translation is a position β moved in the side direction from the “front”. Note that β depends on how much the heat map of the position moved to the side is learned during learning. Therefore, for example, in the case where the heat map is learned assuming the position obtained by moving the parallax position by 100 mm in the positive direction of the X axis with respect to the front, the translation is [100, 0, 0]. For example, in the second embodiment, the translation is [100, 0, 0] and the rotation is [0, 0, 0].

[System]

Pieces of information including a processing procedure, a control procedure, a specific name, various types of data, and parameters described above or illustrated in the drawings may be optionally changed unless otherwise specified.

In addition, each component of each device illustrated in the drawings is functionally conceptual and does not necessarily have to be physically configured as illustrated in the drawings. For example, specific forms of distribution and integration of each device are not limited to those illustrated in the drawings. For example, all or a part thereof may be configured by being functionally or physically distributed or integrated in optional units according to various types of loads, usage situations, or the like. For example, the learning device 10 and the recognition device 50 can be implemented by the same device. Furthermore, the 3D laser sensor 5 may be built in each device or may be connected by communication or the like as an external device of each device.

Moreover, all or any part of individual processing functions performed in each device may be implemented by a central processing unit (CPU) and a program analyzed and executed by the CPU, or may be implemented as hardware by wired logic.

[Hardware]

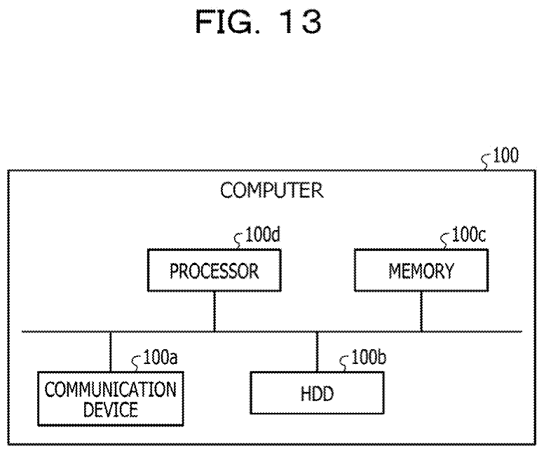

Next, a hardware configuration of the computer such as the learning device 10 and the recognition device 50 will be described. FIG. 13 is a diagram for describing a hardware configuration example. As illustrated in FIG. 13, a computer 100 includes a communication device 100a, a hard disk drive (HDD) 100b, a memory 100c, and a processor 100d. In addition, each of the units illustrated in FIG. 13 is mutually connected by a bus or the like.

The communication device 100a is a network interface card or the like and communicates with another server. The HDD 100b stores programs and DBs for operating the functions illustrated in FIG. 3.

The processor 100d reads a program that executes processing similar to the processing of each processing unit illustrated in FIG. 3 from the HDD 100b or the like, and develops the read program in the memory 100c, thereby operating a process that executes each function described with reference to FIG. 3 or the like. In other words, this process executes functions similar to the functions of each processing unit included in each of the learning device 10 and the recognition device 50. Specifically, taking the recognition device 50 as an example, the processor 100d reads a program having similar functions to the distance image acquisition unit 61, the heat map recognition unit 62, the two-dimensional calculation unit 63, the three-dimensional calculation unit 64, and the like from the HDD 100b or the like. Then, the processor 100d executes a process of executing similar processing to the distance image acquisition unit 61, the heat map recognition unit 62, the two-dimensional calculation unit 63, the three-dimensional calculation unit 64, and the like. Note that the learning device 10 can also be processed using a similar hardware configuration.

As described above, the learning device 10 or the recognition device 50 operates as an information processing device that executes the learning method or the recognition method by reading and executing the program. Furthermore, the learning device 10 or the recognition device 50 may also implement functions similar to the functions of the above-described embodiments, by reading the program described above from a recording medium by a medium reading device and executing the read program described above. Note that this program referred to in other embodiments is not limited to being executed by the learning device 10 or the recognition device 50. For example, the embodiments may be similarly applied to a case where another computer or server executes the program, or a case where these cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented method of skeleton recognition, the method comprising:
acquiring, from a distance image of an object, a learning model that recognizes heat map images obtained by projecting likelihoods of a plurality of joint positions of the object from a plurality of directions;
inputting a distance image to be processed to the learning model and acquiring heat map images in each of the plurality of directions;
calculating three-dimensional coordinates regarding the plurality of joint positions of the object, using the heat map images in each of the plurality of directions and information that indicates a relative positional relationship of the plurality of directions; and
outputting a skeleton recognition result that includes the three-dimensional coordinates regarding the plurality of joint positions.

2. The computer-implemented method according to claim 1, wherein
the calculating includes:
calculating, based on the heat map images, two-dimensional coordinates of the joint positions of the object in a case of viewing the object from each of the plurality of directions; and
calculating the three-dimensional coordinates by using the two-dimensional coordinates of the joint position of each of the plurality of joints calculated in each of the plurality of directions, and the distance image.

3. The computer-implemented method according to claim 1, wherein
the learning model is generated by: generating heat map images in a plurality of directions corresponding to a distance image using the distance image of an object captured in advance and predefined and known position information of a plurality of joints; and performing a learning processing by using training data that has the distance image of the object captured in advance as an explanatory variable, and the generated heat map images in the plurality of directions as objective variables.

4. The computer-implemented method according to claim 2, wherein the plurality of directions includes a front direction with respect to the object and a right above direction with respect to the object.

5. The computer-implemented method according to claim 4, wherein
the calculating of the two-dimensional coordinates includes
calculating a first skeleton position that is two-dimensional coordinates of a skeleton position of the object when the object is viewed from the front direction, by using a first heat map image viewed from the front direction, and
calculating a second skeleton position that is two-dimensional coordinates of a skeleton position of the object when the object is viewed from the right above direction, by using a second heat map image viewed from the right above direction, and
the calculating of the three-dimensional coordinates includes
calculating depth values for the number of joints, by using a center of gravity of the object calculated from the distance image to be processed and the second skeleton position, and
calculating three-dimensional coordinates of the skeleton position of the object, by using the depth values for the number of joints and the first skeleton position.

6. The computer-implemented method according to claim 2, wherein the plurality of directions includes a front direction with respect to the object and a parallax position moved in a side direction from the front direction.

7. The computer-implemented method according to claim 6, wherein
the calculating of the two-dimensional coordinates includes
calculating a first skeleton position that is two-dimensional coordinates of a skeleton position of the object when the object is viewed from the front direction, by using a first heat map image viewed from the front direction, and
calculating a second skeleton position that is two-dimensional coordinates of a skeleton position of the object when the object is viewed from the parallax position, by using a second heat map image viewed from the parallax position, and
the calculating of the three-dimensional coordinates includes
calculating three-dimensional coordinates of the skeleton position of the object, by using parallax information that includes a set value determined in advance when performing capture from the parallax position, the first skeleton position, and the second skeleton position.

8. A non-transitory computer-readable storage medium storing a skeleton recognition program for causing a computer to perform processing, the processing comprising:
acquiring, from a distance image of an object, a learning model that recognizes heat map images obtained by projecting likelihoods of a plurality of joint positions of the object from a plurality of directions;
inputting a distance image to be processed to the learning model and acquiring heat map images in each of the plurality of directions;
calculating three-dimensional coordinates regarding the plurality of joint positions of the object, using the heat map images in each of the plurality of directions and information that indicates a relative positional relationship of the plurality of directions; and
outputting a skeleton recognition result that includes the three-dimensional coordinates regarding the plurality of joint positions.

9. A skeleton recognition system comprising:
a learning device; and
a recognition device, wherein
the learning device includes
a memory; and
a processor coupled to the memory of the recognition device, the processor being configured to perform first processing, the first processing including:
generating heat map images obtained by projecting likelihoods of a plurality of joint positions of an object from a plurality of directions, by using a distance image of the object captured in advance, and position information of a plurality of joints defined in advance; and
learning a learning model that recognizes heat map images in each of the plurality of directions, by using training data that has the distance image of the object captured in advance as an explanatory variable, and the generated heat map images in the plurality of directions as objective variables, and
the recognition device includes
a memory; and
a processor coupled to the memory of the recognition device, the processor of the recognition device being configured to perform second processing, the second processing including:
acquiring the learning model;
inputting a distance image to be processed to the learning model, and acquire the heat map images in each of the plurality of directions;
calculating three-dimensional coordinates regarding positions of the plurality of joints of the object, using the heat map images in each of the plurality of directions and information that indicates a relative positional relationship of the plurality of directions; and
outputting a skeleton recognition result that includes the three-dimensional coordinates regarding the positions of the plurality of joints.

10. A computer-implemented method of learning, the method comprising:
generating heat map images obtained by projecting likelihoods of a plurality of joint positions of an object from a plurality of directions, by using a distance image of the object captured in advance, and position information of a plurality of joints defined in advance; and
training a learning model by using training data that has the distance image of the object captured in advance as an explanatory variable, and the generated heat map images in the plurality of directions as objective variables, the learning model being a model that recognizes heat map images in each of the plurality of directions.

11. A non-transitory computer-readable storage medium storing a learning program for causing a computer to perform processing, the processing comprising:
generating heat map images obtained by projecting likelihoods of a plurality of joint positions of an object from a plurality of directions, using a distance image of the object captured in advance, and position information of a plurality of joints defined in advance; and
learning a learning model that recognizes heat map images in each of the plurality of directions, using training data that has the distance image of the object captured in advance as an explanatory variable, and the generated heat map images in the plurality of directions as objective variables.

12. A learning device comprising:
a memory; and
a processor coupled to the memory, the processor being configured to perform processing, the processing including:
generating heat map images obtained by projecting likelihoods of a plurality of joint positions of an object from a plurality of directions, using a distance image of the object captured in advance, and position information of a plurality of joints defined in advance; and
learning a learning model that recognizes heat map images in each of the plurality of directions, using training data that has the distance image of the object captured in advance as an explanatory variable, and the generated heat map images in the plurality of directions as objective variables.
